(19) United States
(12) Patent Application Publication
(10) Pub. No.: US 2019/0201923 A1
(43) Pub. Date: Jul. 4, 2019

(54) LIQUID DISPENSER AND METHOD OF USING THE SAME

(71) Applicant: Frederic Neil Sorrentino, West Hempstead, NY (US)

(72) Inventor: Frederic Neil Sorrentino, West Hempstead, NY (US)

(21) Appl. No.: 16/236,814

(22) Filed: Dec. 31, 2018

Related U.S. Application Data
(60) Provisional application No. 62/612,954, filed on Jan. 2, 2018.

(51) Int. Cl. B05B 11/00

(52) U.S. Cl. CPC B05B 11/0032

(57) ABSTRACT

A method of dispensing scented liquids from their container. The method embodies a scented liquid dispenser device adapted to operatively associate with various such containers. The scented liquid dispenser device may provide threaded sidewalls to facilitate such removable securement. A top portion of the scented liquid dispenser device provides a plurality of pin-sized holes for dispensing liquid therefrom by squeezing the container. Selective squeezing could create a spray from the pin-sized holes on the top portion that can be directed at the final application area, removing the need for the wasteful hand-application of the scented liquid through the conventional opening of the container.

### CROSS-REFERENCE TO RELATED APPLICATION

This application claims the benefit of priority of U.S. provisional application No. 62/612,954, filed 2 Jan. 2018, the contents of which are herein incorporated by reference.

### BACKGROUND OF THE INVENTION

The present invention relates to liquid dispensers and a method of applying said scented liquids and, more particularly, to a method of dispensing cologne, aftershave, perfume, eau de toilette, essential oils, and the like from a container through pin-sized holes of a top portion by squeezing the container, whereby the top portion is adapted to be retrofitted to pre-existing containers.

When applying scented liquids, such as cologne, aftershave, perfume, eau de toilette, essential oils, or the like, the most effective outcome is to dispense a limited amount to a concentrated area. This way, waste can be eliminated or minimized for what can be very expensive liquids. Such is the problem with current scented liquid application methods; which mainly consist of removing the cap completely and pouring the scented liquid from a relatively large opening, typically into a user's hand for further application. Removal of the entire cap invites waste as the amount dispensed is only limited by the size of the container opening, which make undesirable spillage a possibility. Furthermore, there is an inherent waste of the residue of the scented liquid left on hand.

As can be seen, there is a need for a method of dispensing scented liquids from their container. The method embodies a threaded top with pin-sized holes for dispensing liquid therefrom by squeezing the container. The pin-sized holes on the top portion of the bottle of the product creates a method to dispense said liquid by squeezing the bottle without removing the top portion, eliminating the waste inherent in dispensing liquid by removing the cap completely and pouring the contents out onto the hand. Squeezing could create a spray from the pin size holes on the top portion that can be selectively directed at the final application area, removing the need for hand-application.

### SUMMARY OF THE INVENTION

In one aspect of the present invention, a scented liquid dispenser device includes the following: an upper portion dimensioned to operatively associate with a container of said scented liquid, along an opening of the container; and a plurality of through holes in the upper portion so as to fluidly communicate the opening to outside of the container.

In another aspect of the present invention, the scented liquid dispenser device further includes the following: sidewalls for engaging a neck of the container and threading along said sidewalls for engaging the neck of the container, wherein each through hole has diameter ranging between 0.5 to 4 mm.

In yet another aspect of the present invention, a method of dispensing scented liquid from a pre-existing container includes the following: providing the above-mentioned scented liquid dispenser device, removably securing the scented liquid dispenser device about an opening of the pre-existing container; and squeezing the container so that said scented liquid is urged through the plurality of through holes.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention;

FIG. 3 is a cross-sectional view of an exemplary embodiment of the present invention, taken along line 3-3 in FIG. 2;

FIG. 4 is a cross-sectional view of an exemplary embodiment of the present invention, taken along line 4-4 in FIG. 1; and

FIG. 5 is a section view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of dispensing scented liquids from their container. The method embodies a scented liquid dispenser device adapted to operatively associate with various such containers. The scented liquid dispenser device may provide threaded sidewalls to facilitate such removable securement. A top portion of the scented liquid dispenser device provides a plurality of pin-sized holes for dispensing liquid therefrom by squeezing the container. Selective squeezing could create a spray from the pin-sized holes on the top portion that can be directed at the final application area, removing the need for the wasteful hand-application of the scented liquid through the conventional opening of the container.

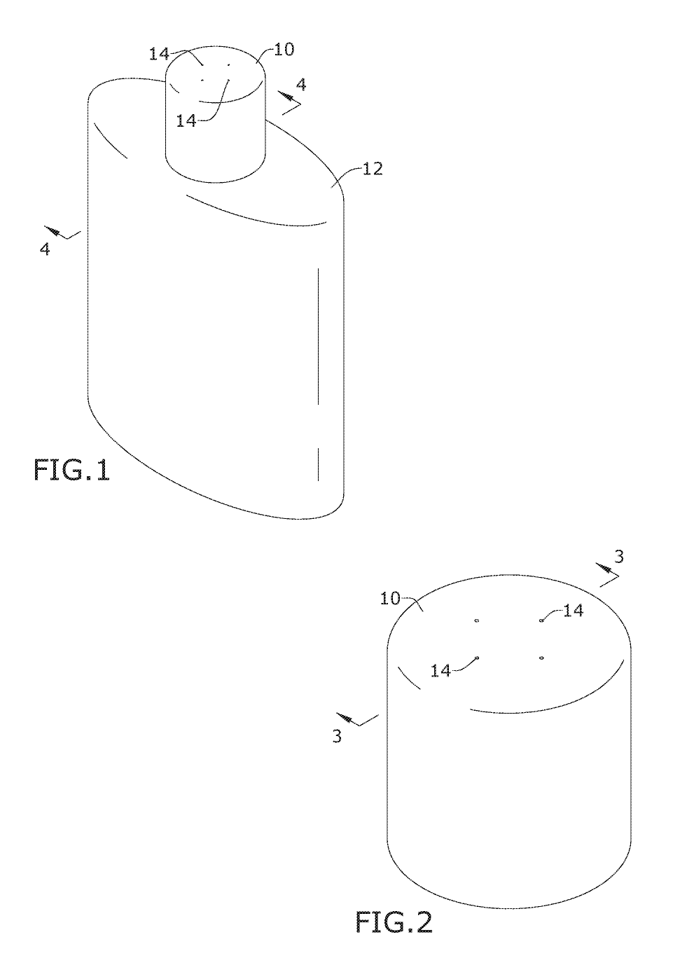

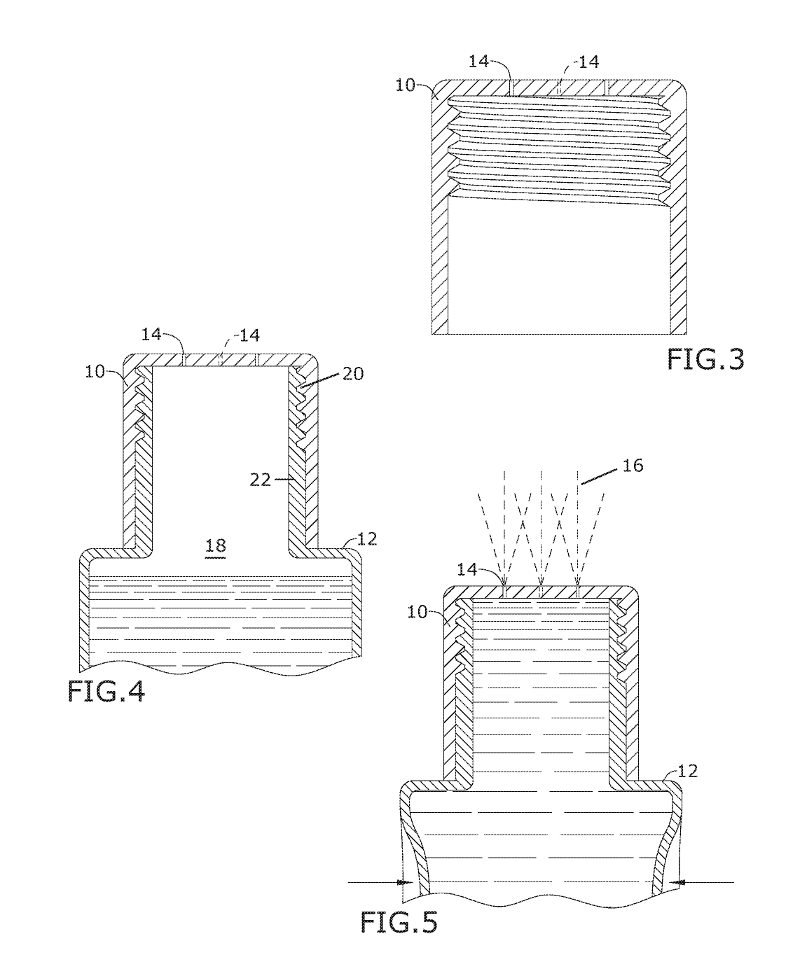

Referring to FIGS. 1 through 5, the present invention may include a scented liquid dispenser device 10 for dispensing liquids 16, including scented liquids, from a container 12. The scented liquid dispenser device 10 is dimensioned to operatively associate with various containers 12, new and pre-existing. The scented liquid dispenser device 10 may have a plurality of pin-sized through holes 14 fluidly connecting the inside of the container 12 with the outside thereof. In certain embodiments, the plurality of pin-sized through holes 14 number two to six through holes 14, thereby limiting the discharge of scented liquid 16.

The scented liquid dispenser device 10 may be a cap that is removably secured to an opening 18 for the container. The cap may be various sizes and dimensions, including but not limited to a cylindrical shape having a diameter ranging between half an inch to three inches. The scented liquid dispenser device 10 may have sidewalls with threading 20 for facilitating this removable securement. The scented liquid dispenser device 10 may be dimensioned and adapted to operatively associated with various shaped and sized pre-existing container necks 22, whereby a user can replace a convention cap with the scented liquid dispenser device 10. The through holes 14 may have diameters that range between 0.5 to 4 mm.

A method of using the present invention may include the following. The present invention disclosed above may be provided. A user may operatively associate the scented liquid dispenser device 10 to the neck 22 of a pre-existing container 12 of scented liquids 16. Then the user may selectively squeeze the container 12, so that a desired amount of the scented liquid 16 is urged through the through holes 14 (typically in spray form, as illustrated in FIG. 5.) at a predetermined application area. The scented liquid dispenser device 10 could replace the pre-existing cap, eliminating the need to remove the cap to dispense the scented liquid 16 and therefore eliminate the waste inherent in pouring the scented liquids 16 onto one's hands prior to final application.

It should be understood, of course, that the foregoing relates to exemplary embodiments of the invention and that modifications may be made without departing from the spirit and scope of the invention as set forth in the following claims.

What is claimed is:

1. A scented liquid dispenser device, comprising:
an upper portion dimensioned to operatively associate with a container of said scented liquid, along an opening of the container; and
a plurality of through holes in the upper portion so as to fluidly communicate the opening to outside of the container.

2. The scented liquid dispenser device of claim 1, further comprising one or more sidewalls for engaging a neck of the container.

3. The scented liquid dispenser device of claim 2, further comprising threading along said one or more sidewalls for engaging the neck of the container.

4. The scented liquid dispenser device of claim 3, wherein each through hole has diameter ranging between 0.5 to 4 mm.

5. The scented liquid dispenser device of claim 4, wherein the plurality of through holes range between two and six through holes.

6. The scented liquid dispenser device of claim 4, wherein the scented liquid dispenser device is a cap, wherein the upper portion is a flat portion thereof having a diameter ranging between half and three inches in diameter, and wherein the one or more sidewalls is cylindrical.

7. A method of dispensing scented liquid from a pre-existing container, comprising:
providing the scented liquid dispenser device of claim 1,
removably securing the scented liquid dispenser device about an opening of the pre-existing container; and
squeezing the container so that said scented liquid is urged through the plurality of through holes.

8. The method of claim 7, wherein each through hole has diameter ranging between 0.5 to 4 mm.

9. The method of claim 7, wherein the scented liquid dispenser device has sidewalls for engaging a neck of the container, and wherein the sidewalls provide threading for engaging the neck of the container.
